(19) United States
(12) Patent Application Publication
(10) Pub. No.: US 2013/0320605 A1
(43) Pub. Date: Dec. 5, 2013

(54) Device for Manufacturing Alignment Film

(71) Applicant: Shaoxin Yu, Shenzhen (CN)

(72) Inventor: Shaoxin Yu, Shenzhen (CN)

(73) Assignee: SHENZHEN CHINA STAR OPTOELECTRONICS TECHNOLOGY CO, LTD., Shenzhen (CN)

(21) Appl. No.: 13/575,303

(22) PCT Filed: Jun. 12, 2012
(86) PCT No.: PCT/CN12/76751

§ 371 Date: Jul. 26, 2012

(30) Foreign Application Priority Data
May 31, 2012 (CN) 201210176480.8

(51) Int. Cl. B23Q 3/18

(52) U.S. Cl. 269/58

(57) ABSTRACT

The present invention provides a device for manufacturing alignment film, which includes: a heat-dissipating board, a coated substrate and a support rack, the coated substrate being disposed above the heat-dissipating board, the support rack being movable, further comprising supporting part and drive unit, the supporting part supporting the coated substrate and drive unit driving supporting part to default positions. The device for manufacturing alignment film of the present invention has the advantage of adaptability to various alignment film manufacturing processes, and manufactured alignment film has no defects of halo area and mura.

### BACKGROUND OF THE INVENTION

1. Field of the Invention

The present invention relates to the field of liquid crystal displaying techniques, and in particular to a device for manufacturing alignment film for liquid crystal display device.

2. The Related Arts

Due to the advantages of high resolution, reduced thickness, light weight, and low power consumption, the liquid crystal display devices find wide applications in the field of displaying in mobile phones, PDA, notebook PC, PC and TV.

Liquid crystal display module usually comprises a thin film transistor (TFT) substrate, a color filter (CF) substrate and a liquid crystal layer. TFT substrate and CF substrate are disposed oppositely, with liquid crystal layer sandwiched between TFT substrate and CF substrate, wherein TFT substrate and CF substrate usually comprise alignment films adjacent to liquid crystal layer.

The alignment film is for pre-orientation of the liquid crystal and requires pre-drying process to evaporate the solvent, such as, NMP, to enable PI to form PI film of uniform thickness. Because the thickness of PI film is about 1000 Å and must be very uniform, various defects may occur when manufacturing process is not properly controlled.

At present, the PI pre-drying is usually through heating the substrate coated with PI solution to evaporate the solvent in the solution to increase the solid contents of PI. The pre-drying process usually encounters two problems. The first is the heated solution is more mobile and halo area may occur when solution coating flows and non-uniformly heated. The second is the mura caused non-uniform heating at supporting points inside coating surface and peripheral pints. The above two problems will reduce the optical quality of the manufactured alignment film.

### SUMMARY OF THE INVENTION

The technical issue to be addressed by the present invention is halo area caused by non-uniform heating at edge of solution and mura caused by non-uniform heating at support points and peripheral points during pre-drying process when manufacturing alignment film.

The present invention provides a device for manufacturing alignment film, which comprises: a heat-dissipating board, a coated substrate and a support rack, the coated substrate being disposed above the heat-dissipating board, the support rack being movable, further comprising supporting part and drive unit, the supporting part supporting the coated substrate and drive unit driving supporting part to default positions.

According to a preferred embodiment of the present invention, the supporting part is made of material with poor thermal conductivity.

According to a preferred embodiment of the present invention, the supporting part is made of Polytetrafluoroethylene (PTFE).

According to a preferred embodiment of the present invention, a metal reflection layer is disposed on bottom surface of the supporting part facing the heat-dissipating board, the metal reflection layer is located between the coated substrate and the heat-dissipating board.

According to a preferred embodiment of the present invention, a plurality of alignment film solution coated areas is disposed on surface of coated substrate away from the supporting part, contact positions between the supporting part and coated substrate correspond to non-coated areas surrounding the alignment film solution coated areas.

According to a preferred embodiment of the present invention, the device for manufacturing alignment film comprises a plurality of support racks, and the drive unit of each support rack is independent from one another.

The present invention provides a device for manufacturing alignment film, which comprises: a heat-dissipating board, a coated substrate and a support rack, a first surface of the coated substrate being disposed with alignment film solution coated areas, the heat-dissipating board supplying radiation heat to the coated substrate, the support rack supporting a second surface opposite to the first surface of the coated substrate, the support rack moving supporting locations of the second surface correspondingly according to location variations of the alignment film solution coated areas, the supporting locations corresponding to non-coated areas surrounding the alignment film solution coated areas.

According to a preferred embodiment of the present invention, the supporting rack comprises a supporting part supporting the coated substrate, and the supporting part is made of Polytetrafluoroethylene (PTFE).

According to a preferred embodiment of the present invention, a metal reflection layer is disposed on bottom surface of the supporting part facing the heat-dissipating board, the metal reflection layer is located between the coated substrate and the heat-dissipating board.

According to a preferred embodiment of the present invention, the device for manufacturing alignment film comprises a plurality of support racks, the drive unit of each support rack is independent from one another, and each drive unit independently drives the supporting rack to default position respectively.

The present invention provides a device for manufacturing alignment film, which comprises: a heat-dissipating board, a coated substrate and support rack, the coated substrate being disposed above the heat-dissipating board, the support rack being movable, further comprising supporting part and drive unit, the supporting part supporting the coated substrate and drive unit driving supporting part to default positions; the supporting part being made of material with poor thermal conductivity; a metal reflection layer being disposed on bottom surface of the supporting part facing the heat-dissipating board, the metal reflection layer being located between the coated substrate and the heat-dissipating board; a plurality of alignment film solution coated areas being disposed on surface of coated substrate away from the supporting part, contact positions between the supporting part and coated substrate corresponding to non-coated areas surrounding the alignment film solution coated areas; the device for manufacturing alignment film comprising a plurality of support racks, the drive unit of each support rack being independent from one another.

According to a preferred embodiment of the present invention, the supporting part is made of Polytetrafluoroethylene (PTFE).

According to a preferred embodiment of the present invention, the device for manufacturing alignment film comprises a plurality of support racks, the drive unit of each support rack is independent from one another, and each drive unit independently drives the supporting rack to default position respectively.

The device for manufacturing alignment film of the present invention has the advantage of adaptability to various alignment film manufacturing processes, and manufactured alignment film has no defects of halo area and mura.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic side view showing the structure of the device for manufacturing alignment film of the present invention;

FIG. 2 is a schematic front view showing the structure of the device for manufacturing alignment film of FIG. 1; and

FIG. 3 is a schematic top view showing the structure of the device for manufacturing alignment film of FIG. 1.

### DETAILED DESCRIPTION OF THE PREFERRED EMBODIMENTS

The following description refers to drawings and embodiments of the present invention. Apparently, the drawings described below show only example embodiments of the present invention and for those having ordinary skills in the art, other drawings may be easily obtained from these drawings without paying any creative effort, and are within the scope of the present invention.

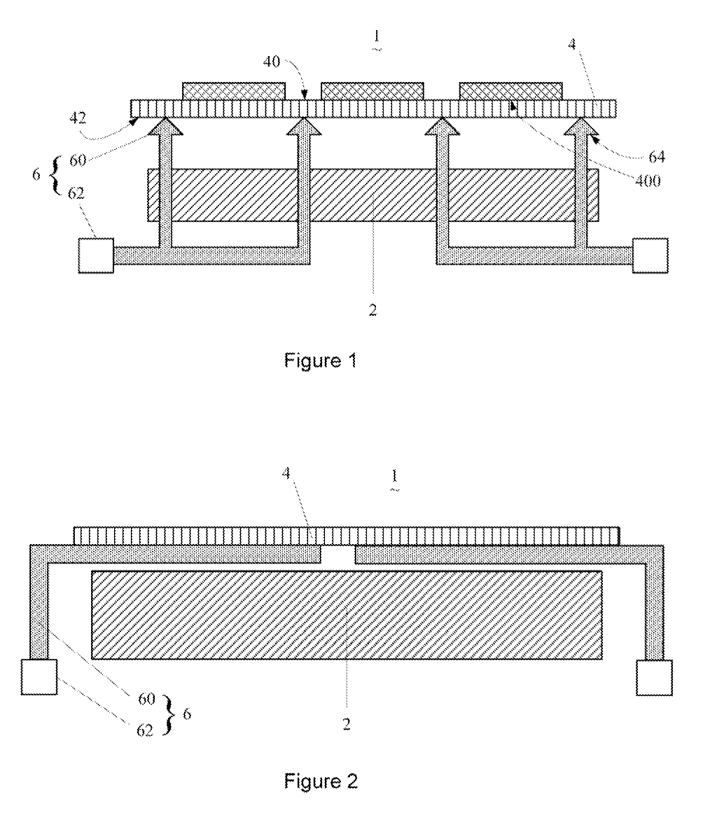

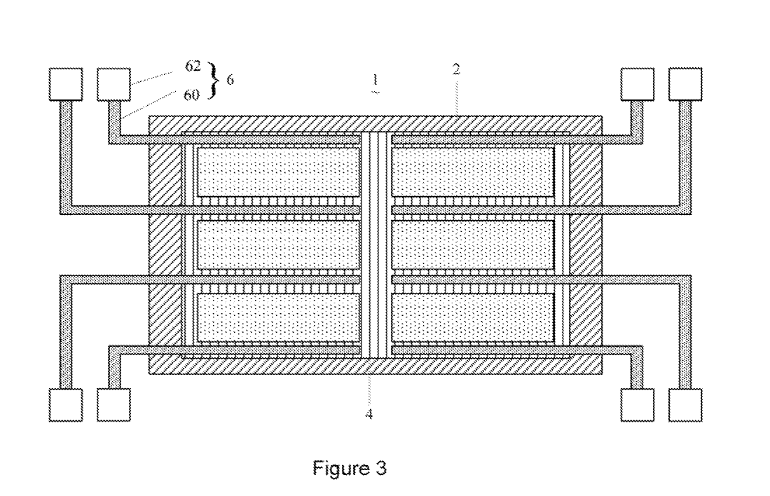

The present invention discloses a device for manufacturing alignment film. Refer to FIGS. 1-3. FIG. 1 is a schematic side view showing the structure of the device for manufacturing alignment film of the present invention. FIG. 2 is a schematic front view showing the structure of the device for manufacturing alignment film of FIG. 1. FIG. 3 is a schematic top view showing the structure of the device for manufacturing alignment film of FIG. 1.

Device 1 for manufacturing alignment film comprises: a heat-dissipating board 2, a coated substrate 4 and a support rack 6.

Heat-dissipating board 2 is a common heating element for dissipating heat and the heat is supplied to coated substrate 4 in radiation form to heat the PI solution carried on surface 40 of coated substrate 4.

Coated substrate 4 is disposed above heat-dissipating board 2. Upper surface 40 is disposed with a plurality of alignment film solution coated areas 400, and each of alignment film solution coated areas 400 is separated from one another with gap. Coated substrate 4 receives radiation heat from heat-dissipating board 2 and conducts the heat to solution coated on upper surface 40 so that solvent of the solution evaporates. This process is the pre-drying process of the alignment film manufacturing process. In the present invention, coated substrate 40 can be flat glass substrate.

Support rack 6 is a movable rack, further comprises supporting part 60 and drive unit 62. Supporting part 60 supports coated substrate 4 and drive unit 62 drives supporting part 60 to default positions.

Specifically, supporting part 60 is made of material with good wear-resistance and poor thermal conductivity. For example, supporting part 60 can be made of Polytetrafluoroethylene (PTFE). PTFE has the characteristics of anti-alkaline, antacid, anti-organic solvent, nearly insoluble to any solvent, resistant to high temperature and low friction coefficient.

In the instant embodiment, supporting part 60 contacts to support coated substrate 40 at lower surface 42 opposite to upper surface 40. In the instant embodiment, supporting part 60 contacts coated substrate 4 at locations corresponding to non-coated areas surrounding alignment film solution coated areas 400. In other words, the locations on lower surface 42 where supporting part 60 contacts coated substrate 4 correspond to the gaps among alignment film solution coated areas 400 on upper surface 40. From another perspective, the contact locations between supporting part 60 and coated substrate 4 has little heat to affect the solution of alignment film solution coated areas 400.

To manufacture alignment films of different sizes and at different locations, the sizes and locations of alignment film solution coated areas 400 are adjustable. To accommodate such adjustment, based on the location variations of alignment film solution coated areas 400, drive unit 62 of support rack 6 drives supporting part 60 accordingly to adjust the locations of supporting part 60 so that supporting part 60 contacts lower surface 42 of coated substrate 4. The present invention may comprise a plurality of support racks 6, and each support rack 6 comprises an independent drive unit 62. In other words, driver units 62 of support racks 6 are mutually independent, and each of driver units 62 can drives each of support racks 6 independently to default position. For example, when the locations of alignment film solution coated areas 400 vary, driver unit 62 moves supporting part 60 to support location on lower surface 42 corresponding to non-coated area after alignment film solution coated areas 400 are adjusted. In the present embodiment, drive unit 62 can be a small drive motor.

Furthermore, a metal reflection layer 64 is disposed on bottom surface (not shown) of supporting part 60 facing heat-dissipating board 2. Metal reflection layer 64 is located between coated substrate 4 and heat-dissipating board 2. Metal reflection layer 64 can reflect heat from heat-dissipating board 2 back to heat-dissipating board 2.

In device 1 for manufacturing alignment film, a part of radiation heat from heat-dissipating board 2 reaches supporting rack 6 and a part reaches lower surface 42 of coated substrate 4. The radiation heat reaching supporting rack 6 is partially absorbed by supporting rack 6, partially reflected by metal reflection layer 64 back to heat-dissipating board 2, and partially penetrating metal reflection layer 64 and conducted to lower surface 42 of coated substrate 4.

Coated substrate 4 uses the heat to heat the solution of alignment film solution coated areas 400 for the solvent to evaporate. In known technique, because the evaporation of solvent carries some heat from the solution, the locations without solution will maintain original heat, which leads to temperature difference at the edge of the solution so that the solution will flow towards the edge. Therefore, after pre-drying, the thickness of the edge of PI layer is thicker than the center area, forming halo area.

In the instant embodiment, the above situation can be reduced or even eliminated mainly because of the two following aspects:

On one hand, supporting part 60 has poor thermal conductivity. Therefore, the heat propagation speed from supporting part 60 to coated substrate 4 is slower and the effect on temperature difference caused by support location is reduced.

On the other hand, metal reflection layer 64 of supporting part 60 can reflect partial heat back to heat-dissipating board 2 so as to further reduce the effect on temperature difference caused by support location. The above two effects can effectively reduce the heat propagation from supporting part 60 to support location of coated substrate 4 so as to reduce or even eliminate the temperature difference at the edge of the solution.

In addition, because driver units 62 are mutually independent and can drive support rack 6 to default position independently, when manufacturing different alignment films, the support locations can be adjusted to avoid causing mura due to uneven heating between support points and peripheral points.

In summary, the device for manufacturing alignment film of the present invention has the advantage of adaptability to various alignment film manufacturing processes, and manufactured alignment film has no defects of halo area and mura.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A device for manufacturing alignment film, which comprises: a heat-dissipating board, a coated substrate and a support rack, the coated substrate being disposed above the heat-dissipating board, the support rack being movable, further comprising supporting part and drive unit, the supporting part supporting the coated substrate and drive unit driving supporting part to default positions.

2. The device for manufacturing alignment film as claimed in claim 1, characterized in that the supporting part is made of material with poor thermal conductivity.

3. The device for manufacturing alignment film as claimed in claim 2, characterized in that the supporting part is made of Polytetrafluoroethylene (PTFE).

4. The device for manufacturing alignment film as claimed in claim 2, characterized in that a metal reflection layer is disposed on bottom surface of the supporting part facing the heat-dissipating board, the metal reflection layer is located between the coated substrate and the heat-dissipating board.

5. The device for manufacturing alignment film as claimed in claim 1, characterized in that a plurality of alignment film solution coated areas is disposed on surface of coated substrate away from the supporting part, contact positions between the supporting part and coated substrate correspond to non-coated areas surrounding the alignment film solution coated areas.

6. The device for manufacturing alignment film as claimed in claim 1, characterized in that the device for manufacturing alignment film comprises a plurality of support racks, and the drive unit of each support rack is independent from one another.

7. A device for manufacturing alignment film, which comprises: a heat-dissipating board, a coated substrate and a support rack, a first surface of the coated substrate being disposed with alignment film solution coated areas, the heat-dissipating board supplying radiation heat to the coated substrate, the support rack supporting a second surface opposite to the first surface of the coated substrate, the support rack moving supporting locations of the second surface correspondingly according to location variations of the alignment film solution coated areas, the supporting locations corresponding to non-coated areas surrounding the alignment film solution coated areas.

8. The device for manufacturing alignment film as claimed in claim 7, characterized in that the supporting rack comprises a supporting part supporting the coated substrate, and the supporting part is made of Polytetrafluoroethylene (PTFE).

9. The device for manufacturing alignment film as claimed in claim 8, characterized in that a metal reflection layer is disposed on bottom surface of the supporting part facing the heat-dissipating board, the metal reflection layer is located between the coated substrate and the heat-dissipating board.

10. The device for manufacturing alignment film as claimed in claim 7, characterized in that the device for manufacturing alignment film comprises a plurality of support racks, the drive unit of each support rack is independent from one another, and each drive unit independently drives the supporting rack to default position respectively.

11. A device for manufacturing alignment film, which comprises: a heat-dissipating board, a coated substrate and support rack, the coated substrate being disposed above the heat-dissipating board, the support rack being movable, further comprising supporting part and drive unit, the supporting part supporting the coated substrate and drive unit driving supporting part to default positions; the supporting part being made of material with poor thermal conductivity; a metal reflection layer being disposed on bottom surface of the supporting part facing the heat-dissipating board, the metal reflection layer being located between the coated substrate and the heat-dissipating board; a plurality of alignment film solution coated areas being disposed on surface of coated substrate away from the supporting part, contact positions between the supporting part and coated substrate corresponding to non-coated areas surrounding the alignment film solution coated areas; the device for manufacturing alignment film comprising a plurality of support racks, the drive unit of each support rack being independent from one another.

12. The device for manufacturing alignment film as claimed in claim 11, characterized in that the supporting part is made of Polytetrafluoroethylene (PTFE).

13. The device for manufacturing alignment film as claimed in claim 11, characterized in that the device for manufacturing alignment film comprises a plurality of support racks, the drive unit of each support rack is independent from one another, and each drive unit independently drives the supporting rack to default position respectively.
